(19) United States
(12) Patent Application Publication
(10) Pub. No.: US 2008/0292379 A1
(43) Pub. Date: Nov. 27, 2008

(54) IMAGE FORMING APPARATUS, IMAGE FORMING METHOD, AND COMPUTER PROGRAM PRODUCT

(76) Inventor: Fuminori Tsuchiya, Osaka (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/115,927

(22) Filed: May 6, 2008

(30) Foreign Application Priority Data
May 23, 2007 (JP) 2007-136488

(51) Int. Cl. G03G 15/00; G06K 15/00

(52) U.S. Cl. 399/401; 358/1.12

(57) ABSTRACT

An order changing unit changes an image forming order from a first page order of an original document to a second page order that is different from the first page order. A conveying unit conveys a recording medium on which an image is formed by an image forming unit to a discharging unit. A determining unit determines whether the image forming order can be changed by the order changing unit.

### CROSS-REFERENCE TO RELATED APPLICATIONS

The present application claims priority to and incorporates by reference the entire contents of Japanese priority document 2007-136488 filed in Japan on May 23, 2007.

### BACKGROUND OF THE INVENTION

1. Field of the Invention

The present invention relates to an image forming apparatus, an image forming method, and a computer program product for forming an image.

2. Description of the Related Art

Currently, various types of image forming apparatuses are available, and they include an electrophotographic type, a thermal transfer type, and an, inkjet type. Particularly, the electrophotographic-type of image forming apparatuses employing an electrophotographic system is widely used. In the electrophotographic system, toner is electrostatically charged and it is attracted by an electrostatic latent image formed on a photosensitive member (for example, a photosensitive drum), so that a toner image is formed on the surface of the photosensitive member. The toner image is then transferred onto a recording medium, and it is fixed to the recording medium by heat and pressure. Electrophotographic-type full color image forming apparatuses are categorized into a single drum type (rotary type) and a tandem type. A single-drum-type full color image forming apparatus includes a single photosensitive member, and a tandem-type full color image forming apparatus includes a plurality of photosensitive members corresponding to each color. The tandem-type full color image forming apparatus is advantageous in printing a full color image in view of its productivity compared with the single-drum type full color image forming apparatus.

If the tandem-type image forming apparatus is in a monocolor printing mode in which a monocolor image (for example, a black and white image) is printed using only one color, it is preferable that photosensitive members (hereinafter, “unnecessary photosensitive members”) corresponding to colors other than the color of the monocolor image do not abut on a transfer member onto which a monocolor toner image is transferred. If the transfer member with the monocolor toner image is pressed against the unnecessary photosensitive members while printing the monocolor image, the monocolor toner image on the transfer member may be disadvantageously transferred onto the unnecessary photosensitive members. If such transfer occurs, the toner image on the transfer member deforms, and moreover, the unnecessary photosensitive members need to be cleaned.

For this reason, while a monocolor image is printed (i.e., in the monocolor printing mode), the unnecessary photosensitive members are moved apart from the transfer member to prevent the unnecessary photosensitive members from abutting on the transfer member. When printing pages of an original document including a full color images and monocolor images, it is required to switch between a full-color printing mode and the monocolor printing mode. When switching the mode, the unnecessary photosensitive members need to separate from or abut on the transfer member, i.e., a positioning operation is performed. During the positioning operation, however, image forming cannot be performed, and this lowers the level of productivity. Such inconvenience can be prevented by using a stacker that temporarily stores therein sheets. However, the use of such a stacker increases the cost and it is not preferable in view of cost reduction.

For example, Japanese Patent Application No. 2004-272021 discloses an image forming apparatus capable of changing an image forming order, in which pages (images) are printed, from an original order that is the page order of an original document to a different order such that two pages are simultaneously formed on each photosensitive member. This increases the level of productivity.

However, image forming by this image forming apparatus is limited to double-sided printing, and the surface of each photosensitive member needs to have a large area because two pages are formed thereon (i.e., each photosensitive member needs to have a circumference twice a length of one sheet). The size of the photosensitive member increases the size of the image forming apparatus, and this hinders cost reduction. Particularly, if this image forming apparatus is the tandem-type full color image forming apparatus including four photosensitive members each having a large surface, the size thereof significantly increases.

### SUMMARY OF THE INVENTION

It is an object of the present invention to at least partially solve the problems in the conventional technology.

According to an aspect of the present invention, there is provided an image forming apparatus including an image forming unit that forms an image on a recording medium, a feeding unit that feeds the recording medium to the image forming unit, a reversing unit that reverses a front surface and a rear surface of the recording medium on which the image is formed by the image forming unit, and a discharging unit that discharges the recording medium from the recording medium on which the image is formed by the image forming unit, an order changing unit that changes an image forming order from a first page order of an original document to a second page order that is different from the first page order, a conveying unit that conveys the recording medium on which the image is formed by the image forming unit to the discharging unit, and a determining unit that determines whether the image forming order can be changed by the order changing unit.

Furthermore, according to another aspect of the present invention, there is provided an image forming method for an image forming apparatus that includes an image forming unit that forms an image on a recording medium, a feeding unit that feeds the recording medium to the image forming unit, a reversing unit that reverses a front surface and a rear surface of the recording medium on which the image is formed by the image forming unit, and a discharging unit that discharges the recording medium from the recording medium on which the image is formed by the image forming unit. The method includes changing an image forming order from a first page order of an original document to a second page order that is different from the first page order. The second page order requires less conveyed to an inversion path. Thereafter, the sheet 4 is conveyed to the registration roller 3 again via a roller 19 and to the secondary-transfer roller 16 again, and a toner image is transferred onto the back surface of the surface onto which the toner image has been transferred. Thereafter, the fixing unit fixes the toner image on the surface of the sheet 4, and the sheet 4 is discharged to the outside with the counterclockwise rotation of the discharging roller 18.

FIG. 2 is a block diagram of the image forming apparatus 100. The image forming apparatus 100 includes the exposing unit 11, a central processing unit (CPU) 21, a flash read only memory (ROM) 22, a random access memory (RAM) 23, a writing control unit 24, a motor driver 25, and a printer engine controller 28.

The CPU 21 controls the image forming apparatus 100. The flash ROM 22 is rewritable, and it stores therein an instruction code to be executed by the CPU 21. The RAM 23 can temporarily stores data necessary for software control. The printer engine controller 28 communicates with a host computer (not shown) and receives image data in addition to a print start instruction from the host computer. The printer engine controller 28 divides the image data into pieces of Y, M, C, K image data.

The printer engine controller 28 issues a print number of times of switching a printing mode than the first page order while forming the image, and with the second page order, the conveying unit can convey the recording media to the discharging unit in the first page order.

Moreover, according to still another aspect of the present invention, there is provided a computer program product comprising a computer usable medium having computer readable program codes embodied in the medium for forming an image in an image forming apparatus that includes an image forming unit that forms an image on a recording medium, a feeding unit that feeds the recording medium to the image forming unit, a reversing unit that reverses a front surface and a rear surface of the recording medium on which the image is formed by the image forming unit, and a discharging unit that discharges the recording medium from the recording medium on which the image is formed by the image forming unit, which when executed cause a computer to execute changing an image forming order from a first page order of an original document to a second page order that is different from the first page order. The second page order requires less number of times of switching a printing mode than the first page order while forming the image, and with the second page order, the conveying unit can convey the recording media to the discharging unit in the first page order.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image forming apparatus according to an embodiment of the present invention;

FIG. 2 is a block diagram of the image forming apparatus shown in FIG. 1;

FIG. 3 is a schematic diagram for explaining an order changing process of Example 2 of the image forming apparatus shown in FIG. 1;

FIG. 4 is a schematic diagram for explaining the order changing process of Example 3 of the image forming apparatus shown in FIG. 1;

FIG. 5 is a flowchart of a determination process; and

FIG. 6 is a flowchart of an image forming process and a sheet conveying process.

### DETAILED DESCRIPTION OF THE PREFERRED EMBODIMENTS

Exemplary embodiments of the present invention are explained in detail below with reference to the accompanying drawings.

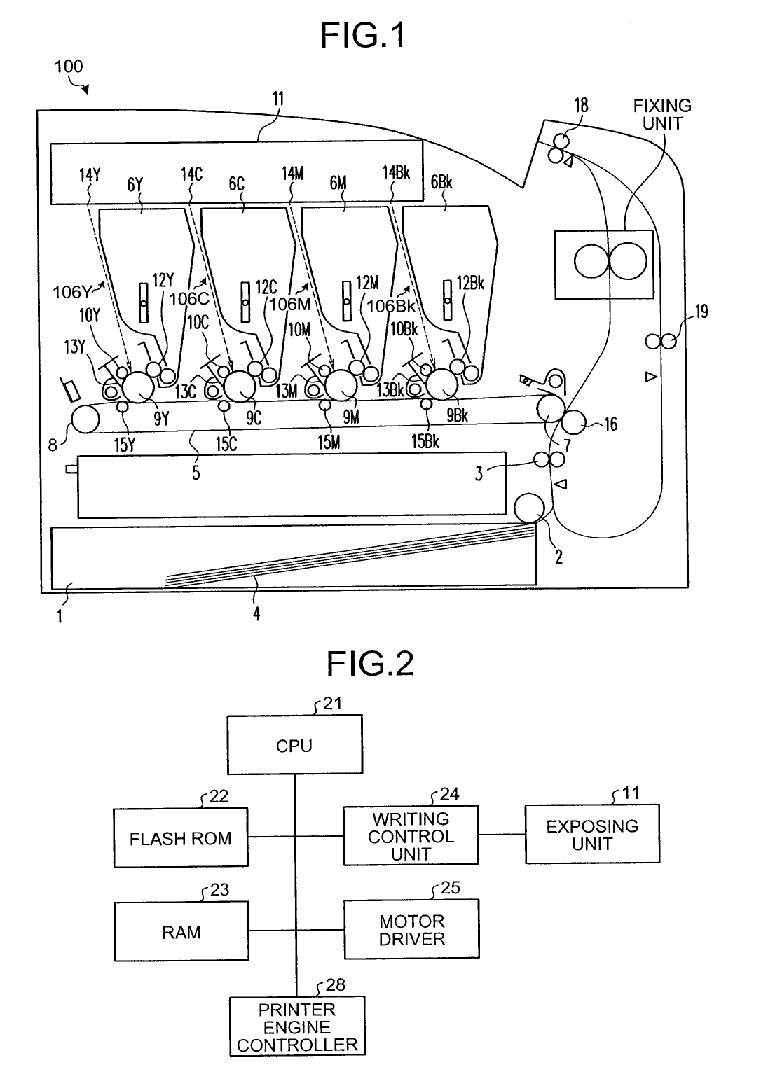

FIG. 1 is a schematic diagram of an image forming apparatus 100 according to an embodiment of the present invention. The image forming apparatus 100 is a tandem-type image forming apparatus, and it includes a transfer belt 5 that is opposed to image forming units 106Bk (black), 106M (magenta), 106C (cyan), and 106Y (yellow) respectively including all-in-one (AIO) cartridges 6Bk (black), 6M (magenta), 6C (cyan), and 6Y (yellow). The transfer belt 5 rotates counterclockwise. The AIO cartridges 6Bk, 6M, 6C, and 6Y have the same structure, and they are opposed to the transfer belt 5 and positioned as shown in FIG. 1. The image forming units 106Bk, 106M, 106C, and 106Y form a black image, a magenta image, a cyan image, and a yellow image, respectively.

The AIO cartridge 6Bk is explained in detail below. Other AIO cartridges (6M, 6C, and 6Y) have basically the same configuration as that of the AIO cartridge 6Bk.

The transfer belt 5 is an endless belt, and it is stretched across and supported by a secondary-transfer driving roller 7 and a transfer-belt supporting roller 8. The secondary-transfer driving roller 7 is rotated by a drive motor (not shown). The transfer belt 5 is moved by the drive motor, the secondary-transfer driving roller 7, and the transfer-belt supporting roller 8.

The image forming unit 106Bk further includes a photosensitive member 9Bk, a charger 10Bk, an exposing unit 11, the developing unit 12Bk, and a cleaning blade 13Bk. Similarly, the image forming units 106M, 106C, and 106Y further include the photosensitive members 9M, 9C, and 9Y (the photosensitive members 9Bk, 9M, 9C, and 9Y are collectively numbered as “9”), chargers 10M, 10C, and 10Y, the exposing unit 11, developing units 12M, 12C, and 12Y (the developing units 12Bk, 12M, 12C, and 12Y are collectively numbered as “12”), and cleaning blades 13M, 13C, and 13Y. The exposing unit 11 emits laser lights 14Bk, 14M, 14C, and 14Y based on color images to be formed by the image forming units 106Bk, 106M, 106C, and 106Y to the photosensitive members 9Bk, 9M, 9C, and 9Y, so that the photosensitive members 9Bk, 9M, 9C, and 9Y are exposed.

When forming an image, a surface of the photosensitive member 9Bk is uniformly charged in a dark sate by the charger 10Bk and the surface of the photosensitive member 9Bk is exposed to the laser light 14Bk, so that an electrostatic latent image is formed thereon. The developing unit 12Bk develops the electrostatic latent image with black toner, so that a black toner image is formed on the surface of the photosensitive member 9Bk.

A primary-transfer roller 15Bk rotates such that the black toner image on the surface of the photosensitive member 9Bk can be primary-transferred onto a surface of the transfer belt 5 at a position where the photosensitive member 9Bk and the transfer belt 5 abut on each other (primary-transfer position). Thus, a black tone image is formed on the surface of the transfer belt 5. Thereafter, the cleaning blade 13Bk cleans the surface of the photosensitive member 9Bk, and the image forming unit 106Bk waits for the next image.

The transfer belt 5 with the black toner image on its surface is conveyed to the image forming unit 106M. The image forming unit 106M forms a magenta toner image on a surface of the photosensitive member 9M in the same manner as that for forming the black toner image, and the magenta toner image is primary-transferred onto the surface of the transfer belt 5 and superimposed on the black toner image.

The transfer belt 5 with the black and magenta toner images on its surface is conveyed to the image forming units 106C and 106Y in this order. A cyan toner image formed on the surface of the photosensitive member 9C and a yellow toner image formed on the surface of the photosensitive member 9Y are sequentially primary-transferred onto the surface of the transfer belt 5 and superimposed on the black and the magenta toner images. Thus, a full-color toner image is formed on the surface of the transfer belt 5. Thereafter, the transfer belt 5 with the full color image on its surface is conveyed to a secondary-transfer roller 16.

When forming a black and white image as a monocolor image, the image forming process is performed to form a black image only. During this process, primary-transfer rollers 15M, 15C, and 15 Y are moved apart from the photosensitive members 9M, 9C, and 9Y.

When forming an image, the top one of sheets 4 stacked on a tray 1 is fed with counterclockwise rotation of a feeding roller 2 to a registration roller 3 and stopped by the registration roller 3. The registration roller 3 starts its counterclockwise rotation such that the sheet 4 is conveyed and a toner image on the surface of the transfer belt 5 can be appropriately secondary-transferred onto a surface of the sheet 4.

After the toner image on the surface of the transfer belt 5 is secondary-transferred onto the surface of the sheet 4, a fixing unit fixes the toner image on the sheet 4 by heat and pressure. The sheet 4 is then discharged to the outside with clockwise rotation of a discharging roller 18.

When performing double-sided printing, the discharging roller 18 is rotated counterclockwise before the sheet 4 passes the discharging roller 18. Thus, the sheet 4 is preparation instruction to the CPU 21. After being notified of completion of the print start preparation by the CPU 21, the printer engine controller 28 sends the pieces of Y, M, C, K image data to the writing control unit 24. The writing control unit 24 causes the exposing unit 11 to emit laser lights to the surfaces of the photosensitive members 9, so that electrostatic latent images of the respective colors are formed thereon.

According to instructions from the CPU 21, the motor driver 25 rotates and stops motors (not shown) connected to the photosensitive members 9, the developing units 12, the transfer-belt supporting roller 8, the secondary-transfer driving roller 7, the secondary-transfer roller 16, the feeding roller 2, the roller 19, and the discharging roller 18. In addition, the motor driver 25 can cause a cam mechanism (not shown) to make the photosensitive members 9 and the transfer belt 5 be in contact with or separate from each other.

A process for changing an order in which pages (images) of an original document are formed on sheets (hereinafter, “order changing process”) and a process for conveying sheets (hereinafter, “sheet conveying process”) that are performed by the image forming apparatus 100 are explained below. In the explanation below, a part of the image forming apparatus 100 along a sheet path, in which the sheet 4 is conveyed, from the tray 1 to the feeding roller 2 is referred to as “feeding unit”, a part of the image forming apparatus 100 along the sheet path from the feeding roller 2 to the discharging roller 18 is referred to as “transfer unit”, and a part of the image forming apparatus 100 along the sheet path from the discharging roller 18 to the registration roller 3 via the roller 19 is referred to as “reversing unit”. In addition, an area where the transfer belt 5 abuts on the secondary-transfer roller 16 is referred to as “image transferring position”.

Example 1 of the image forming apparatus 100 is explained below, focusing on basic operations of the order changing process and the sheet conveying process. In Example 1, one sheet can be stored in the reversing unit, and three pages are printed. A first page is a full color image, a second page is a monocolor image, and a third page is a full color image.

The feeding unit feeds a first sheet, and a first page (full color image) is transferred from the transfer belt 5 onto the first sheet at the image transferring position. The first sheet is directly discharged to the outside. The feeding unit feeds a second sheet and a third page (full color image) is transferred from the transfer belt 5 onto the second sheet at the image transferring position. The second sheet with the third page is conveyed to and temporarily stored in the reversing unit while a printing mode is switched from a full-color printing mode to a monocolor printing mode and the feeding unit feeds a third sheet. The second page (monocolor image) is transferred from the transfer belt 5 onto the third sheet at the image transferring position and the third sheet is directly discharged to the outside. Because the second sheet is reversed when being conveyed to the reversing unit for the first time, the second sheet stored in the reversing unit is conveyed via the image transferring position (no image is transferred) to the reversing unit again to reverse the second sheet once again.

Thereafter, the second sheet is conveyed from the reversing unit to the image transferring position again (no image is transferred) and discharged to the outside.

The order changing process and the sheet conveying process are performed by the CPU 21. The CPU 21 reads instruction codes stored in the flash ROM 22. According to the instruction codes, the CPU 21 controls each unit such as the exposing unit 11 and the photosensitive members 9 via the writing control unit 24 and the motor driver 25. The CPU 21 operates in the same manner in Examples 2 and 3 of the image forming apparatus 100, which are explained below.

In Example 1, feeding of a sheet from the feeding unit to the image transferring position is performed simultaneously with discharging of a sheet from the image transferring position to the outside. Similarly, feeding of a sheet from the feeding unit to the image transferring position is performed simultaneously with conveying of a sheet from the image transferring position to the converting unit. Furthermore, conveying of a sheet from the converting unit to the image transferring position is performed simultaneously with conveying of a sheet from the image transferring position to the outside (this simultaneous operation is also performed in Examples 2 and 3).

If the image forming order is not changed from an original order that is an order of the pages (hereinafter, page order) and the pages are printed in the page order, the printing mode needs to be switched twice. On the other hand, if the image forming order is changed from the original order to a different order (hereinafter, “a new order”) and the pages are printed in the new order, the printing mode needs to be switched only once. In addition, because the second sheet with the third page is passed through the reversing unit twice, the sheets are discharged to the outside and stacked in the page order.

A time required for conveying a sheet to each unit is defined as follows:

A: Time from when a sheet is fed from the feeding unit until the center of the sheet reaches the center of the image transferring position

B: Time from when conveying of the sheet at the center of the image transferring position is started until the center of the sheet reaches the center of the reversing unit

C: Time from when conveying of the sheet at the center of the reversing unit is started until the center of the sheet reaches the center of the image transferring position

D: Time from when conveying of the sheet at the center of the reversing unit to the outside is started until the sheet (the trailing edge thereof) is discharged to the outside

E: Time required for switching the printing mode When the images are printed in the page order, the total printing time TP1 can be calculated by

TP1=A+2×MAX(A,D,E)+D (1)

When the image are printed in the new order, the total printing time TP2 can be calculated by

TP2=A+MAX(A,D)+MAX(A,B,E)+MAX(D,C)+B+C+D (2)

Depending on E, TP of Equation (2) may be shorter than that of Equation (1).

In Example (1), a computer of the image forming apparatus 100 (for example, the CPU 21) calculates TP1 of Equation (1) and TP2 of Equation (2), and compares TP1 and TP2. If TP1 is shorter than TP2, the CPU 21 determines not to change the image forming order. The values of TP1 and TP2 and a command for the order changing process are temporarily stored in the RAM 23. On the other hand, when the CPU 21 determines to change the image forming order, the CPU 21 reads the command from the RAM 23 and changes the image forming order. This operation is performed in Examples 2 and 3.

Example 2 of the image forming apparatus 100 is explained below. In Example 2, the image forming order is changed such that the number of switching the printing mode can be reduced as in Example 1. However, not as in Example 1, a larger number of images are printed that include a set of full color images and a set of monocolor images that are mixed in an irregular order. As in Example 1, one sheet can be stored in the reversing unit.

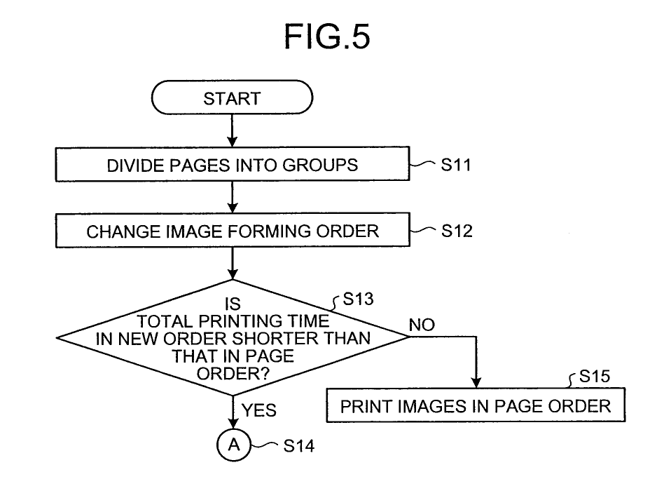

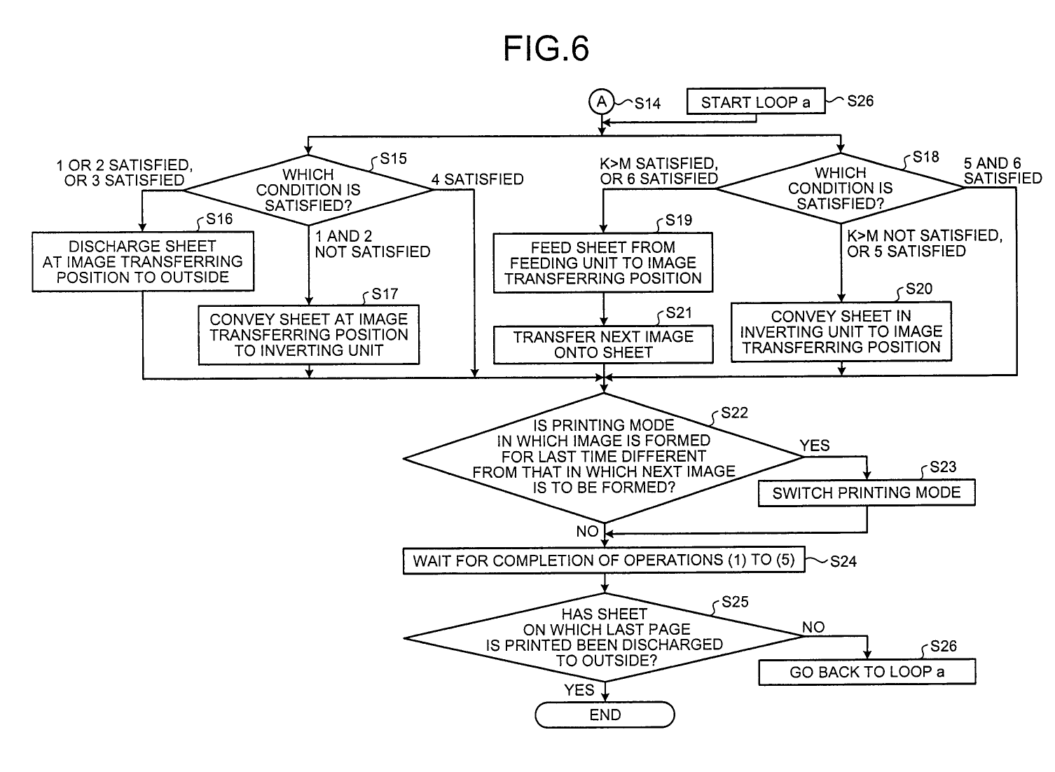

FIG. 5 is a flowchart of a process for determining the image forming order (i.e., determining whether the image forming order is to be changed) (hereinafter, “determination process”). FIG. 6 is a flowchart of the image forming process and the sheet conveying process. The determination process is explained below.

Pages (images) of an original document to be printed are divided into groups (Step S11). If a first image is a full color image, a set of full color images from the first full color image to a full color image followed by a first monocolor image is defined as an image group S₁. A set of monocolor images from the first monocolor image to a monocolor image followed by a full color image is defined as an image group S₂. In this manner, the images to be printed are divided into groups. In the explanation, the number of images (pages) of an image set Sₙ is referred to as |Sₙ|.

The image forming order is changed according to an algorithm for determining the image forming order (Step S12).

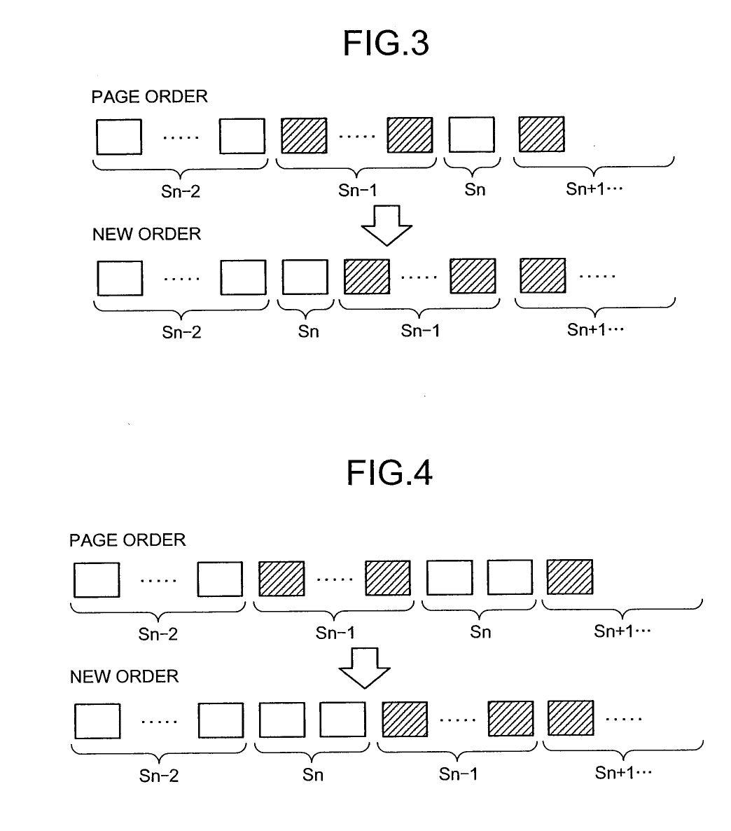

The order changing process is explained in detail below with reference to FIG. 3. The images are originally arranged in this order: a full color image group Sₙ₋₂, a monocolor image group Sₙ₋₁, a full color image group Sₙ, and a monocolor image group Sₙ₊₁.

In the order changing process, the image group Sₙ corresponding to |Sₙ|=1 is searched among the image groups from the first page. When the image group Sₙ₋₁ is found, the image group Sₙ and the image group Sₙ₋₁ are replaced with each other. Subsequently, an image group Sₘ corresponding to |Sₘ|=1 (m≧n+1) is searched among the groups from the image group Sₙ₊₁. When the image group Sₘ is found, the image group Sₘ and the image group Sₘ₋₁, are replaced with each other. The above operation is repeated to the last page.

By performing the order changing process, it is possible to reduce the number of switching the image printing mode. Specifically, as shown in FIG. 3, if the image forming order is not changed from the original (page) order and the images are printed in the original order, the image printing mode needs to be switched for three times. On the other hand, as shown in FIG. 3, if the image forming order is changed from the original order to the new order and the images are printed in the new order, the image printing mode needs to be switched only once.

Thereafter, the total printing time required for printing the images in the page order and the total printing time required for printing the image in the new order are calculated. The total printing times are compared and it is determined whether the total printing time required in the new order is shorter than that in the page order (Step S13). When the total printing time in the new order is shorter than that in the page order (YES at Step S13), the image are printed in the new order. When the total printing time in the new order is not shorter than that in the page order (NO at Step S13), the images are printed in the page order (Step S15).

The total printing time in the page order is represented by MAX(A,D)×(|sₙ₋₁|−1)+3×MAX(A,D,E). The total printing time in the new order is represented by MAX(B,A,E)+MAX(D,A)×|Sₙ₋₁|+MAX(D,C)+B+C+MAX(D,A).

When the total printing time in the page order is equal to or shorter than the total printing time in the new order (NO at Step S13), the images are printed in the page order (Step S15).

When the total printing time in the page order is longer than the total printing time in the new order (YES at Step S13), the images are printed in the new order (Step S15) as shown in the flowchart of FIG. 6.

When it is determined that the image are to be printed in the new order, it is determined whether to discharge a sheet at the image transferring position to the outside or convey the sheet to the reversing unit (Step S15). A page (image) having been printed on the last sheet discharged to the outside is referred to as page n. When page n+1 has been transferred onto a sheet at the image transferring position (Condition 1) or the sheet at the image transferring position has already passed through the reversing unit for multiple times of an even number (i.e., the sheet is not reversed from the original state) (Condition 2), the sheet at the image transferring position is discharged to the outside (Step S16). When neither of Conditions 1 nor Condition 2 has occurred, the sheet at the image transferring position is conveyed to the reversing unit (Step S17). When no sheet has been discharged to the outside (i.e., the sheet at the image transferring position is the first sheet) (Condition 3), the sheet at the image transferring position is discharged to the outside (Step S16). When no sheet is present in the image transferring position (Condition 4), no operation is performed.

When it is determined that the images are to be printed in the new order, it is determined which of a sheet from the feeding unit and the sheet at the reversing unit is conveyed to the image transferring position (Step S18).

A page (image) having been printed on the sheet in the reversing unit is referred to as page m and a page (image) to be transferred onto a sheet to be fed from the feeding unit is referred to as page k. When “k” is larger than “m”, a sheet is fed from the feeding unit to the image transferring position (Step S19). If “k” is not larger than “m”, the sheet in the reversing unit is conveyed to the image transferring position (Step S20). The exceptional cases are as follows. When it is determined at Step S18 that the total number of sheets having been fed from the feeding unit reaches the number of the pages to be printed (“Condition 5”), the sheet in the reversing unit is conveyed to the image transferring position (Step S20). On the other hand, when it is determined at Step S18 that no sheet is present in the reversing unit (“Condition 6”), a sheet is fed from the feeding unit to the image transferring position (Step S19). If both of Conditions 5 and 6 are satisfied, no operation is performed.

After a sheet is fed from the feeding unit at Step S19, the next page is transferred onto the sheet at the image transferring position (Step S21). When the sheet fed at Step S19 is the first one, the first page is transferred onto the sheet at the image transferring position at Step S21.

Thereafter, it is determined whether the printing mode is to be switched, i.e., whether the printing mode in which an image is formed on a sheet for the last time is different from that in which the next image is to be formed on a sheet (Step S22). When the printing modes are different from each other (YES at Step S22), the printing mode is switched (Step S23). On the other hand, when the printing modes are the same (NO at Step S22), are waited completion of the following operations (1) to (5) (Step S24):

(1) Feeding a sheet from the feeding unit to the image transferring position

(2) Discharging a sheet at the image transferring position to the outside

(3) Conveying a sheet at the image transferring position to the reversing unit

(4) Conveying a sheet in the reversing unit to the image transferring position

(5) Switching the printing mode

The operation not to be performed can be ignored.

Subsequently, it is determined whether the operations are completed (Step S25). When a sheet on which the last page is printed has not been discharged to the outside (NO at Step S25), the process control goes back to and start a loop and start the loop a (Step S26) (i.e., the process control goes back to Step S15 or Step S18). When the sheet on which the last page is printed has been discharged to the outside (YES at Step S25), the process is completed.

If the first page is a monocolor image, the process is performed in the same manner as that explained above except that full color image groups are treated as monocolor image groups and monocolor image groups are treated as full color image groups.

Example 3 of the image forming apparatus 100 is explained below. In Example 3, when printing images of full color image groups and monocolor image groups that are mixed in an irregular order, the image forming order is changed such that the number of switching the printing mode can be reduced as in Example 2. In addition, the reversing unit can store two sheets in a queue (first-in, first-out (FIFO)). The determination process, the image forming process, and the sheet conveying process are basically performed in the same manner as Example 2, and only different operations are explained below.

The order changing process of Example 3 is explained with reference to FIG. 4. Before the image forming order is changed, a full color image group Sₙ₋₂, a monocolor image group Sₙ₋₁, a full color image group Sₙ, and a monocolor image group Sₙ₊₁ are arranged and to be formed in this order.

In the order changing process, an image group Sₙ corresponding to |Sₙ|=2 is searched among the image groups from the first page. When the image group Sₙ₋₁ is found, the image group Sₙ and the image group Sₙ₋₁ are replaced with each other. Subsequently, an image group Sₘ corresponding to |Sₘ|=2 (m≧n+1) is searched among the groups from the monocolor image group Sₙ₊₁. When the image group Sₘ is found, the image group Sₙ and the image group Sₙ₋₁ are replaced with each other. This operation is repeated to the last page.

By performing the order changing process, it is possible to reduce the number of switching the image printing mode, which is required to print the images. Specifically, as shown in FIG. 4, the image printing mode needs to be switched for three times when the image forming order is not changed from an original order, i.e., page order, and the image groups Sₙ₋₂ to Sₙ₊₁ are printed in the page order. On the other hand, when the image forming order is changed as explained above, the image printing mode needs to be switched only once.

If the image groups Sₙ and Sₘ that are replaced with each other correspond respectively to |Sₙ=1 and to |Sₘ|=1, the image forming order process and the conveying process are performed as Example 2 and the same explanation is not repeated below.

A total printing time in the page order is represented by 3×MAX(A,D,E)+MAX(A,D)×(|Sₙ₋₁−1). A total printing time in a new order changed by the order changing process is represented by MAX (B,A)+MAX(B,A,E)+MAX (A,D)×|Sₙ₋₁|+2×MAX(D,C)+2×MAX(C,B).

The flow of the determination process, the image forming process, and the image conveying process is basically same as that explained above with reference to FIGS. 5 and 6 and the same explanation is not repeated below.

According to Examples 1 to 3, the reversing unit can store therein one sheet or two sheets. However, the reversing unit can be configured to store three sheets or more.

The image forming apparatus 100 performs processing in accordance with the process executed by the computer (CPU 21) based on a program command. The computer issues instructions to the computer units to perform the processes and achieve units and function, for example, as follows. The CPU 21 controls and causes the writing control unit 24 to change the image forming order from the page order to a new one. The CPU 21 determines which of the page order and the new requires a shorter time, and determines the image forming order. If the new order requires a shorter time, the CPU 21 controls the motor driver 25 such that the images are formed on sheets in the new order and the sheets are discharged to the outside in the page order. As explained above, the processes and the units of the image forming apparatus 100 are achieved by a combination of the program and the computer.

A computer-readable recording medium that stores therein software program codes for achieving the functions of the image forming apparatus 100 can be used. In this case, the CPU 21 reads and executes the program codes stored in the recording medium. The program codes can be directly loaded via a communication line without a recording medium.

The program codes read from the recording medium or loaded via the communication line and executed by the CPU 21 realizes the functions of the image forming apparatus 100.

The recording medium is, for example, a Floppy™ disk, a hard disk, an optical disk, a magnet-optical disk, a compact disk read only memory (CD-ROM), a compact disk recordable (CD-R), a non-volatile memory card, a read-only memory (ROM) and a magnet tape.

As described above, according to an aspect of the present invention, it is possible to provide a reasonable image forming apparatus configured to increase productivity while not increasing the size and cost of the image forming apparatus without a special device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus including an image forming unit that forms an image on a recording medium, a feeding unit that feeds the recording medium to the image forming unit, a reversing unit that reverses a front surface and a rear surface of the recording medium on which the image is formed by the image forming unit, and a discharging unit that discharges the recording medium from the recording medium on which the image is formed by the image forming unit, the image forming apparatus comprising:
an order changing unit that changes an image forming order from a first page order of an original document to a second page order that is different from the first page order;
a conveying unit that conveys the recording medium on which the image is formed by the image forming unit to the discharging unit; and
a determining unit that determines whether the image forming order can be changed by the order changing unit.

2. The image forming apparatus according to claim 1, wherein the order changing unit changes the image forming order from the first page order to the second page order with less number of times of switching a printing mode than the first page order while forming the image and with which the conveying unit can convey the recording media to the discharging unit in the first page order.

3. The image forming apparatus according to claim 1, wherein the determining unit determines the image forming order based on number of sheets that can be stored in the reversing unit.

4. The image forming apparatus according to claim 1, wherein the conveying unit conveys the recording media on which the image is formed in the second page order to the discharging unit by sorting the recording medium in the first page order.

5. The image forming apparatus according to claim 1, wherein the conveying unit conveys the recording media on which the image is formed in the second page order to the discharging unit by sorting the recording medium in the first page order using the reversing unit.

6. The image forming apparatus according to claim 1, wherein
the determining unit calculates a first total printing time required for forming the image in the first page order and a second total printing time required for forming the image in the second page order, and when the second total printing time is shorter than the first total printing time, the determining unit determines that the image forming order can be changed by the order changing unit.

7. The image forming apparatus according to claim 6, wherein the determining unit calculates the first total printing time and the second total printing time based on a time required to switch a printing mode and number of times of switching the printing mode.

8. The image forming apparatus according to claim 6, wherein the determining unit calculates the first total printing time and the second total printing time based on a time required for conveying the recording medium to each subsequent unit.

9. An image forming method for an image forming apparatus that includes an image forming unit that forms an image on a recording medium, a feeding unit that feeds the recording medium to the image forming unit, a reversing unit that reverses a front surface and a rear surface of the recording medium on which the image is formed by the image forming unit, and a discharging unit that discharges the recording medium from the recording medium on which the image is formed by the image forming unit, the image forming method comprising:
changing an image forming order from a first page order of an original document to a second page order that is different from the first page order, wherein
the second page order requires less number of times of switching a printing mode than the first page order while forming the image, and with the second page order, the conveying unit can convey the recording media to the discharging unit in the first page order.

10. The method according to claim 9, wherein the changing includes determining the image forming order based on number of sheets that can be stored in the reversing unit.

11. The method according to claim 9, further comprising conveying the recording media on which the image is formed in the second page order to the discharging unit in the first page order.

12. The method according to claim 9, further comprising conveying the recording media on which the image is formed in the second page order to the discharging unit in the first page order using the reversing unit.

13. The method according to claim 9, wherein the changing includes
calculating a first total printing time required for forming the image in the first page order and a second total printing time required for forming the image in the second page order; and
changing, when the second total printing time is shorter than the first total printing time, the image forming order from the first page order to the second page order.

14. The method according to claim 13, wherein the calculating includes calculating the first total printing time and the second total printing time based on a time required to switch a printing mode and number of times of switching the printing mode.

15. The method according to claim 13, wherein the calculating includes calculating the first total printing time and the second total printing time based on a time required for conveying the recording medium to each subsequent unit.

16. A computer program product comprising a computer usable medium having computer readable program codes embodied in the medium for forming an image in an image forming apparatus that includes an image forming unit that forms an image on a recording medium, a feeding unit that feeds the recording medium to the image forming unit, a reversing unit that reverses a front surface and a rear surface of the recording medium on which the image is formed by the image forming unit, and a discharging unit that discharges the recording medium from the recording medium on which the image is formed by the image forming unit, which when executed cause a computer to execute;
changing an image forming order from a first page order of an original document to a second page order that is different from the first page order, wherein
the second page order requires less number of times of switching a printing mode than the first page order while forming the image, and with the second page order, the conveying unit can convey the recording media to the discharging unit in the first page order.
